(19) United States
(12) Patent Application Publication
(10) Pub. No.: US 2010/0295721 A1
(43) Pub. Date: Nov. 25, 2010

(54) RADAR DEVICE

(76) Inventors: Thomas Focke, Ahrbergen (DE); Juergen Hasch, Stuttgart (DE); Stefan Gaier, Stuttgart (DE); Lars Weikert, Stuttgart (DE); Thomas Hansen, Hildesheim (DE)

Correspondence Address: KENYON & KENYON LLP, ONE BROADWAY, NEW YORK, NY, 10004, US

(21) Appl. No.: 12/733,732

(22) PCT Filed: Aug. 25, 2008
(86) PCT No.: PCT/EP2008/061056

§ 371 Date: Aug. 16, 2010

(30) Foreign Application Priority Data
Sep. 20, 2007 (DE) 102007045013.5

(51) Int. Cl. G01S 13/93; G01S 13/10; G01S 13/32

(52) U.S. Cl. 342/70; 342/201

(57) ABSTRACT

A radar device has an antenna as well as a switching module, the switching module being designed to set an electric signal to be provided to the antenna in such a way that, depending on the switching, the antenna either emits a continuous modulated radar signal for a long range or a pulsed modulated radar signal for a short range.

### BACKGROUND OF THE INVENTION

1. Field of the Invention

The present invention relates to a radar device, a method for the radar-supported detection of an environment, and a computer program.

2. Description of Related Art

Radar systems having antennas, whose main lobe direction is swept across a specific angular range as a function of a frequency, are often referred to as frequency scanners. Such frequency scanners operate using, for example, FMCW (frequency-modulated continuous wave) modulation in order to realize a frequency-modulated continuous wave radar, or using so-called step-FMCW modulations in order to provide a pulsed frequency-modulated continuous wave radar.

Because of an update rate of less than 10 ms aimed for in the automotive field, and ranges of approximately 200 m, only narrow frequency ranges are able to be run through, depending on the type of modulation. Since the frequency ranges are so narrow, the radar systems to be used as an alternative can usually separate a plurality of radar targets to be scanned only in a range of a few meters relative to their linear distance. Such resolutions are normally sufficient for applications for great distances (long range). For functions that require a higher distance resolution at lower update rates, which is necessary especially in the case of applications for short distances (short range), the latter radar systems having pulse modulation are employed, in which case the main lobes or the main lobe directions of the antennas are not swept across the frequency.

If the intention is to detect an environment both in a short range and in a long range with the aid of radar, in order to thereby provide both long range as well as short range applications, then it will be necessary to use a plurality of antennas or sensors to provide and/or detect radar radiation.

A pulse-radar device for detecting a distance range between approximately 10 cm to approximately 6 m at an analog resolution in an order of magnitude of approximately 0.25 mm is known from the published international patent document WO 96/19737 A1. This device includes a plurality of antennas, which are situated next to each other in parallel and possibly also at a distance from each other. As an alternative, these antennas may also be placed next to each other at an offset.

Furthermore, the published international patent document WO 96/12322 A2 describes a directional radar array having a plurality of antennas. This array can be operated using frequency-modulated continuous waves. To provide beam scanning, the antennas are situated next to each other and thus form a wave front in the direction of a region to be scanned.

### BRIEF SUMMARY OF THE INVENTION

The present invention provides a radar device having an antenna as well as a switching module, the switching module being designed to adjust an electrical signal to be provided to the antenna in such a way that, depending on the switching, the antenna either emits a continuous modulated radar signal for a far distance range or a pulsed modulated radar signal for a short distance range.

Among other things, the introduced radar device thus is suitable for detecting an environment through the use of electromagnetic waves and for sampling or scanning it in the process. By switching the electric signal for the antenna—the antenna providing electromagnetic waves from the electric signal—the radar device is able to be operated for a short-range detection of objects located at a short distance, and also for a long range detection, in which objects are located at a greater distance. This radar device requires only one antenna, which has a flexible design for the short range as well as the long range detection through a suitable modification of the electric signal.

In one development, the antenna is designed to perform frequency-sensitive scanning. Furthermore, the antenna is able to spatially vary an emitted main lobe region of the radar signal. In addition, the antenna of the radar device sweeps the main lobe area across an angular range as a function of a frequency. As an alternative or in addition, the antenna is able to vary the width of the main lobe area.

The electric signal is usually generated by the source. If the radar device is in operation, the electric signal is routed via a feed line to a switching module, which has at least one switch implemented as high-frequency switch. By appropriate switching of the switching module, either a continuous signal for the long range or a pulsed signal for the short range will then be provided. If the switching module supplies a plurality of electric signals, then they are able to be mixed via a mixing unit or a mixer and forwarded to the antenna. Depending on the form in which the electric signal is supplied, the antenna emits either a continuously modulated radar signal or a pulsed modulated signal.

The radar device is able to be mounted on a vehicle, e.g., a motor vehicle, and designed to detect an environment of the vehicle.

In the method according to the present invention for the radar-supported detection of an environment, an antenna is supplied with an electric signal, and this signal is switched in such a way that, depending on the switching, the antenna emits either a continuous modulated radar signal for a long range or a pulsed modulated radar signal for a short range.

In one refinement, this signal is able to be switched in this manner via a switching module having high-frequency switches.

In one specific development, a frequency-modulated continuous wave radar signal is used in the process; furthermore, it is possible to vary the width of a main lobe by which the radar signal is emitted.

The device according to the present invention, or at least one component of the device, is designed to execute all of the steps of the described method. Furthermore, individual functions of the at least one component of the radar device may also be realized as steps of the method according to the present invention.

The computer program according to the present invention, having program code means, is designed to implement all of the steps of a provided method when the computer program is executed on a computer or a corresponding processing unit, especially a system according to the present invention.

Moreover, the present invention also relates to a computer program product having program code means, which are stored on a computer-readable data carrier, in order to execute all of the steps of a method according to the present invention when the computer program is executed on a computer or a corresponding processing unit, in particular a device according to the present invention.

In one refinement, depending on the switching, using the radar device a method for long range scanning may be executed in an operation using a continuous modulated radar signal, or for short range detection in an operation using a pulsed modulated radar signal.

The use of the present invention makes it possible, among other things, to scan an environment of an object realized as a vehicle, for example, both in the short range and in the long range, and to sample it thus, and in so doing satisfy situation-related different requirements with regard to ranges and update rates.

In one development of the present invention, it is possible to combine in one radar sensor and thus the antenna, an FMCW modulation method as well as a pulse modulation method using an antenna whose main lobe direction is able to be swept across the frequency. By suitable, especially distance-dependent, selection of the individual modulation method, taking a sampling or scanning range into account, and/or conditioned by an environmental situation, both modulation methods or modulation types are able to be optimally utilized within the framework of the present invention. In one development of the present invention, this frequency-controlled source cooperates with at least one high-frequency switch toward this end, in particular two main switches of the switching module, and the electric signal generated by the source is switched by this at least high-frequency switch. In so doing, the source, the switching module and the frequency-scanning antenna are combined with one another via a control unit of the radar device. Furthermore, it is possible to cover a larger area of the environment to be detected in a flexible manner using only a single sensor, especially while taking other applications into account for which the environment is detected.

In further developments, the short range or the long range is able to be adapted according to the situation. If required, further modulation types or variations, e.g., a PN modulation, in which a bit sequence instead of a frequency sequence is used for the modulation, a frequency-division multiplex FMCW modulation, in which a plurality of channels for modulated frequencies are operated simultaneously, an FSK (frequency shift keying) modulation or frequency change signaling or the like are used in an adapted and suitably operated radar device.

It is understood that the features mentioned above and the features yet to be described below may be used not only in the combination given in each case but also in other combinations or individually, without departing from the scope of the present invention.

### BRIEF DESCRIPTION OF SEVERAL VIEWS OF THE DRAWING

FIG. 1 shows a first example embodiment of a radar device according to the present invention in the execution of a first operating mode, in a schematic representation.

FIG. 2 shows the radar device shown in FIG. 1 in the execution of a second operating mode, in a schematic representation.

FIG. 3 shows a first example of a configuration of a visual range in a radar-supported detection of an environment, in a schematic illustration.

FIG. 4 shows a second example of the configuration of a visual range in a radar-supported detection of an environment, in a schematic illustration.

### DETAILED DESCRIPTION OF THE INVENTION

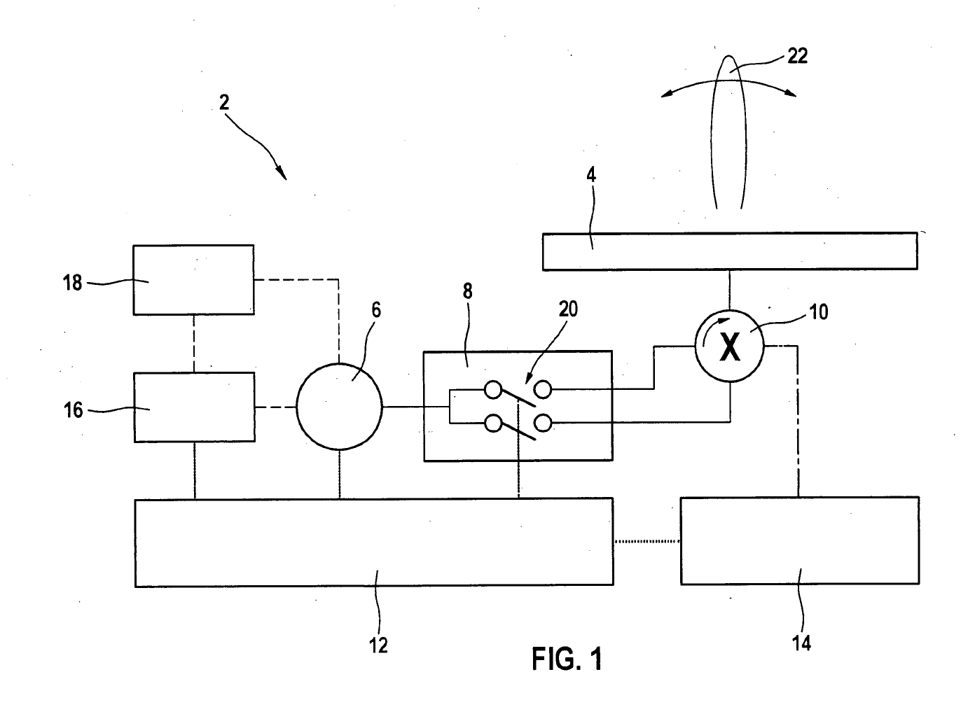

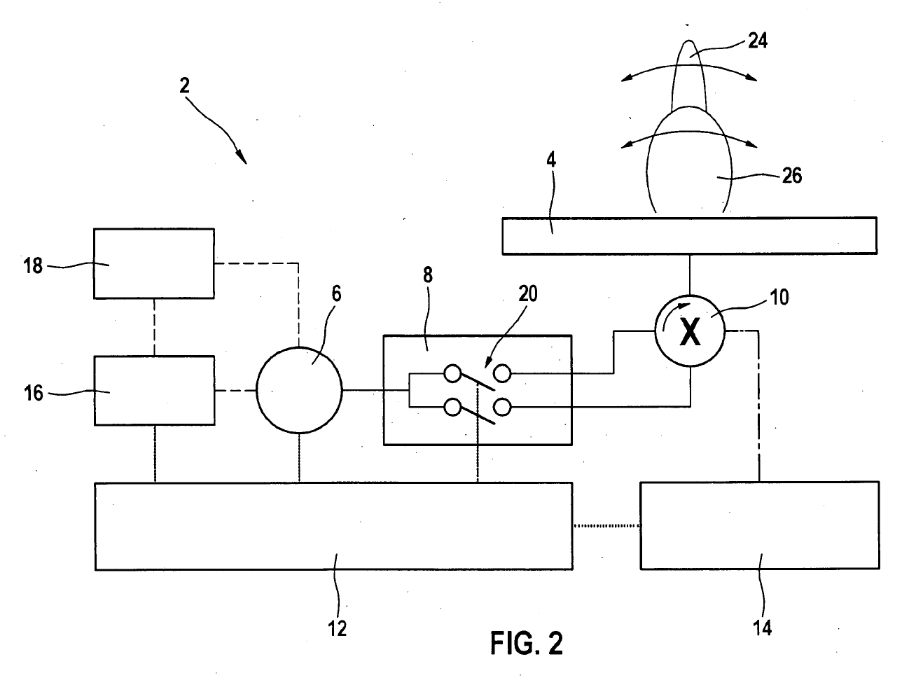

The schematically illustrated specific embodiment of a radar device 2 shown in FIGS. 1 and 2 includes a frequency-scanning antenna 4, a frequency-controlled source 6, a switching module 8, which has two high-frequency switches 20, a mixer unit 10, a central control unit 12, a signal-processing unit 14, a PLL module 16, as well as a component and a module 18, which includes a DRO unit as well as a further mixer unit.

In each case radar device 2 is controlled by central control unit 12. To sample or scan a distant region, the specific embodiments use FMCW-based modulation methods. The necessary electric signals are provided by source 6 in the form of frequency-modulated signals. For the long range, high-frequency switches 20 of switching module 8 are set to the through position, so that antenna 4 receives the unchanged electric signals via mixer unit 10. To detect the environment, antenna 4 emits radar signals in the form of a narrow main lobe 22 for the long range. As indicated by the curved double arrow, main lobe 22 is to be swept back and forth across an angular range as a function of a frequency of the radar signal.

Reference to FIG. 2 is made for the short range operation. For an operation of this type high-frequency switches 20 of switching module 8 are set in such a way that the electric signal supplied by source 6 is pulsed, so that pulses are generated from this electric signal. These pulses are likewise supplied to the antenna via mixing device 10. In addition, however, a width of the main lobe is now varied, so that a method for scanning the environment in the near range is performed using a wide main lobe 26 and in the long range using the narrow main lobe 24. Furthermore, broad main lobe 26 is briefly arrested in one direction via a so-called step FMCW.

Antenna 4 includes suitable radiation means to vary the width. By varying a width of the main lobe, the update rate and the range, among other things, are adapted according to the situation.

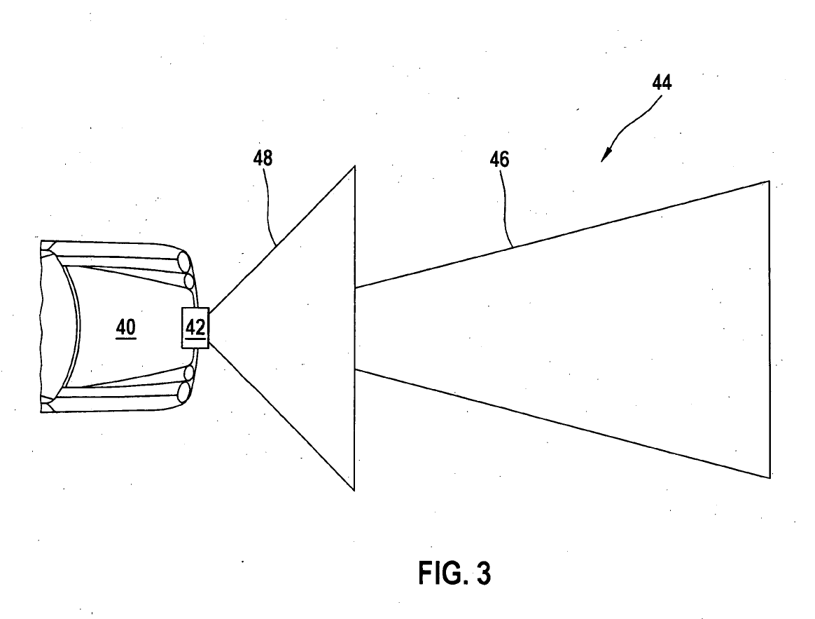

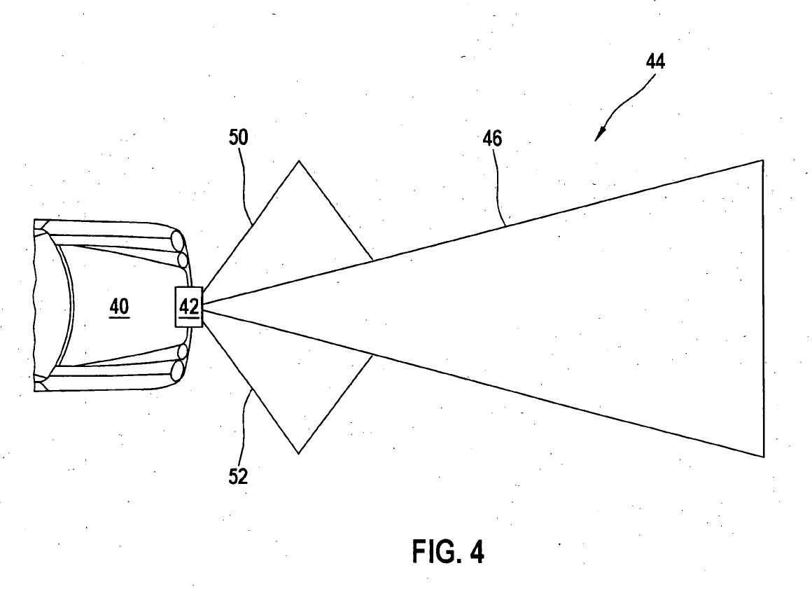

FIGS. 3 and 4 show a front region of a motor vehicle 40 on which a second specific embodiment of a radar device 42 is mounted. When radar array 42 is operating, a main lobe region 44 is operated at a narrow angular range 46 in the straight-ahead direction of motor vehicle 40, using a frequency-modulated radar signal.

Because of the flexible option of switching between FMCW and pulsed operation, the use of present radar device 42 permits the realization of two different coverage scenarios.

With regard to a development of main lobe region 44 in the short range, in which a pulsed frequency-modulated radar signal is used, FIG. 3 shows a broadening 48 of main lobe region 44 in a schematic view.

FIG. 4 shows an alternative development of main lobe region 44 in the short range. In the short range, a pulse-modulation method covers only edge regions 50, 52, in particular.

1-12. (canceled)

13. A radar device, comprising:
an antenna;
a switching module configured to selectively set an electric signal provided to the antenna such that, depending on the setting, the antenna emits one of a continuous modulated radar signal for a long-range detection or a pulsed modulated radar signal for a short-range detection.

14. The radar device as recited in claim 13, wherein the antenna is configured to perform frequency-sensitive scanning.

15. The radar device as recited in claim 14, wherein the antenna is configured to spatially vary an emitted main lobe region of the radar signal.

16. The radar device as recited in claim 15, wherein the antenna is configured to scan the main lobe region across a selected angular range as a function of a frequency.

17. The radar device as recited in claim 15, wherein the antenna is configured to vary the width of the main lobe region.

18. The radar device as recited in claim 15, further comprising:
a source for supplying the electric signal.

19. The radar device as recited in claim 16, wherein the radar device is situated on a vehicle and configured to detect an environment of the vehicle.

20. A method for radar-based detection of an environment, comprising:
supplying an electric signal to an antenna via a switch; and
selectively switching by the switch a setting of the signal such that, depending on the switching, the antenna emits one of a continuous modulated radar signal for a long-range detection or a pulsed modulated radar signal for a short-range detection.

21. The method as recited in claim 20, wherein a frequency-modulated continuous wave radar signal is used.

22. The method as recited in claim 21, wherein the width of a main lobe of the emitted radar signal is varied.

23. A computer-readable data storage medium storing a computer program having program codes which, when executed on a computer, controls a method for radar-based detection of an environment, the method comprising:
supplying an electric signal to an antenna via a switch; and
selectively switching by the switch a setting of the signal such that, depending on the switching, the antenna emits one of a continuous modulated radar signal for a long-range detection or a pulsed modulated radar signal for a short-range detection.
